(19) United States
(12) Patent Application Publication
(10) Pub. No.: US 2005/0125276 A1
(43) Pub. Date: Jun. 9, 2005

(54) System and method for event tracking across plural contact mediums

(76) Inventor: Grigore Rusu, Austin, TX (US)

Correspondence Address: HAMILTON & TERRILE, LLP, P.O. BOX 203518, AUSTIN, TX, 78720, US

(21) Appl. No.: 10/728,692

(22) Filed: Dec. 5, 2003

(51) Int. Cl. G06F 17/60

(52) U.S. Cl. 705/9; 705/1

(57) ABSTRACT

An event tracking system tracks customer interactions to obtain product information that are made across plural contact mediums and displays an intuitive directed graph for analysis of the customer interactions. Each customer interaction is logged at each contact medium with a labeled reference associated with the content of the interaction, a time stamp and an identifier for the product or product user. An event modeling engine analyzes the log to identify contact sessions as contacts by the same identifier within a predetermined time so that an event tracking graphical user interface module prepares each contact session for display as a path of nodes interconnected by edges. Selected directed graph characteristics are highlighted, such as transitions from one contact medium to another or contact session volumes associated with an edge that have a relative volume compared with other contact sessions.

### BACKGROUND OF THE INVENTION

1. Field of the Invention

The present invention relates in general to the field of event tracking, and more particularly to a system and method for tracking customer interactions across plural contact mediums relating to information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The variety of functions performed by information handling systems and the variety of hardware and software components used to build information handling systems generally results in complexity and confusion by users in the selection and maintenance of information handling systems. For instance, users often rely on manufacturer advice when deciding on the configuration of an information handling system for purchase and when attempting to troubleshoot problems that arise in the operation of an information handling system. Often users view contacting manufacturers by telephone as the most convenient way to obtain information for purchasing, maintaining or troubleshooting an information handling system. In response, manufacturers rely on telephone centers manned by trained operators who typically respond to user inquiries with scripts provided by a Customer Relationship Management (“CRM”) system. CRM systems set up processes, policies, mediums and workflows based on anticipated user behavior. CRM systems that handle the complex variety of issues related to information handling systems are typically highly tuned and implemented with complex database schemas that handle millions of user inquiry logs but that, consequently, have difficulty adapting to variations or exceptions in user behavior. Thus, logging and analyzing user inquiries to a CRM system tends to provide limited information for improvement of the user experience.

Although users tend to prefer the telephone for contacting manufacturers, manufacturers are generally able to reduce costs substantially if users instead rely on other contact mediums, such as e-mail, instant messaging, web-based support, and integrated self-help support. In some instances, manufacturers escalate user inquiries with on-site visits or return shipment of a system to the manufacturer for analysis and repair at the factory that cost even more than telephone support. In order to reduce costs, manufacturers typically attempt to reduce user reliance on telephone contacts and escalation to system return by improving the effectiveness of other types of less-expensive contacts, such as self-service and web-based support that do not require direct real-time interaction with an agent of the manufacturer. For instance, a user is more likely to use a self-service module loaded on an information handling system if self-service offers an intuitive interface that quickly homes in on information of interest to the user. On the other hand, poorly crafted self-help that leads down rabbit trails not only frustrates users but also discourages subsequent reference to self-help in favor of the perceived accuracy of the more direct interaction of a telephone conversation or system return.

Information handling system manufacturers attempt to limit sales and service costs by improving user experiences with less-expensive self-help resources, such as on-board modules and web-based references. One technique for analyzing user interactions with self-help resources is the use of “web analytics” to analyze log files from user web site visits and aggregate a traffic map from these logs. Generally, web analytics are limited to web-based interactions and are implemented on top of conventional database techniques. Web-analytics have difficulty in keeping up with the large volume of contacts experienced by some manufacturers and struggle to present an analysis understandable in a manner that allows modifications to self-help processes, policies and workflows to improve the user interaction experience. Further, web-analytics do little to aid in improving the user interaction experience through other types of contact mediums, such as on-board self-help interaction of telephone contact interaction. CRM and web analytic tools fail to provide an easily understood analysis for an information handling system manufacturer to modify contact interaction scripts for all contact mediums in a manner that effectively adapts to actual versus predicted user interactions.

### SUMMARY OF THE INVENTION

Therefore a need has arisen for a system and method which tracks events of user interactions across plural contact mediums.

In accordance with the present invention, a system and method are provided which substantially reduce the disadvantages and problems associated with previous methods and systems for tracking events. Product user contact interactions are tracked to identify contact sessions for display as a directed graph.

More specifically, logs at plural contact mediums track user interactions with product information scripts by labeled reference, time stamp and product or user identifier. For example, logs are kept at an information handling system product call center as agents follow a script to identify and correct system difficulties, and logs are kept at an information handling system product self-help center as product users navigate a web-based self-support resource. The logs are communicated to an event log module of an event tracking system for analysis by an event modeling engine that identifies contact sessions of product users. The contact sessions across plural contact mediums are identified by associating a given product user's interactions with the product user's identifier that occur within a predetermined time in any of plural contact mediums. In this manner, product user interactions that transition from self-support to agent-support resources are identified. An event tracking graphical user interface module prepares the contact sessions for display as a directed graph with a path that proceeds through a node for each labeled reference that the user interacted with over the contact session.

The present invention provides a number of important technical advantages. One example of an important technical advantage is that contact events are tracked across plural mediums and presented for analysis through an intuitive graphical user interface without requiring additional rules for management of contacts across the mediums. Relatively large volumes of user inquiries that escalate from a node of a less-costly contact medium along a path to a node of a more expensive contact medium are highlighted to indicate problem areas in need of refinement. Highlighted paths indicate a breakdown of user experience in a particular subject matter to allow a manufacturer to piece together an efficient manner individual customer interactions for building a behavioral model to manage future interactions. This customer centric flexible model is scalable to adapt information conveyance in desired subject matters according to actual customer behavior instead of expected behavior and thus offers substantial improvement in managing customer interactions with complex subject matters, such as information handling system purchase, maintenance and troubleshooting.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for event tracking across plural contact mediums;

FIG. 2 depicts a graphical user interface of a directed graph of contact sessions across plural contact mediums; and

FIG. 3 depicts an instance view of a directed graph of contact sessions.

### DETAILED DESCRIPTION

Event tracking of product user interactions with a product manufacturer across plural contact mediums presents an intuitive tool for analyzing customer behavior to adapt communications over the contact mediums to simplify the product user experience. User interactions relating to complex products, such as information handling systems, are managed to reduce manufacturer sales, maintenance and troubleshooting costs by adapting self-help communication mediums to better meet user queries without resort to more expensive agent-based communication mediums, such as telephone contacts. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

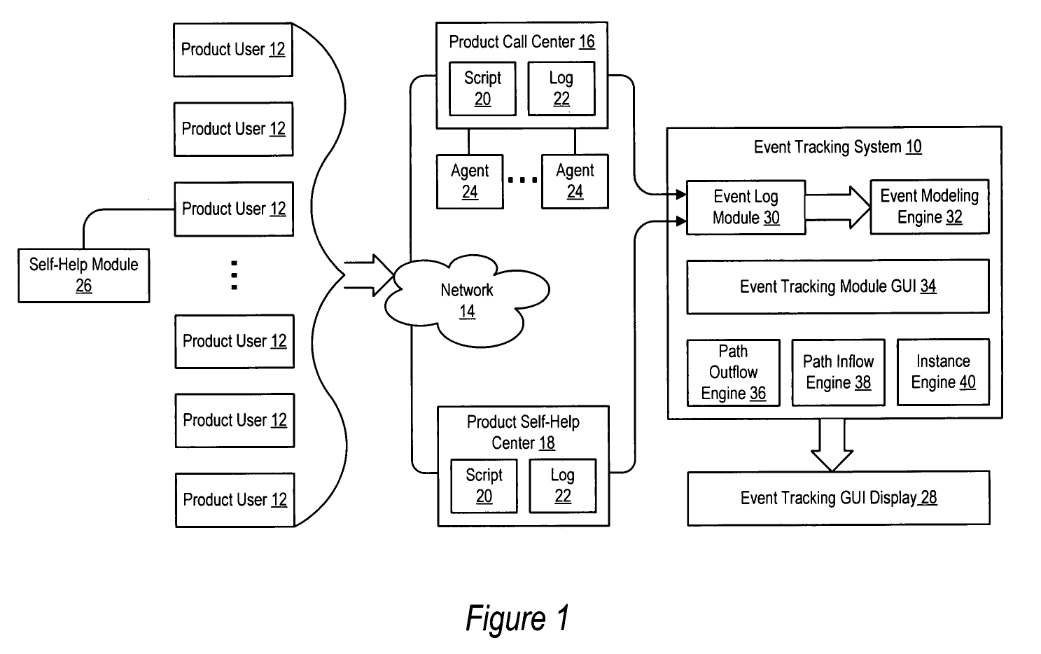

Referring now to FIG. 1, a block diagram depicts a system 10 for event tracking across plural contact mediums. Product users 12 contact the product's manufacturer to obtain product information through plural types of contact mediums, such as a network 14 that interfaces the product user with a product call center 16 or a product self-help center 18. For instance, an information handling system product user 12 is typically provided with information handling system product information stored in a number of locations to aid in purchase selection, maintenance and troubleshooting of the information handling system. Product user 12 accesses the product information through local or remote look-up by topics that the product manufacturer organizes to quickly and efficiently address inquiries made by a product user.

One type of contact medium is a telephone call from a product user 12 to the product manufacturer so that the product user can discuss desired product information with an agent of the manufacturer. Product call center 16 provides product user 12 with product information through agents 24 that reference scripts 20 having topically organized product information available for addressing inquiries by subject matter. As agent 24 communicates with a product user 12, agent 24's progress through a script 20 is tracked in log 22 by labeled references that correspond to script locations. For instance, a complaint by product user 12 to an agent 24 that an information handling system product will not boot initiates a script 20 to isolate and correct the problem. The script may begin at a first labeled reference that confirms the availability of power to the information handling system and progress through a series of labeled references to reload system configuration information in the BIOS. Log 22 stores each reference by agent 24 to a script location by the labeled reference associated with the script location along with a time stamp and an identifier for the product user, such as a unique identifier for the information handling system or a customer identification number. In alternative embodiments, direct contact mediums between product users and manufacturer agents include e-mail or instant message contact mediums. Generally the more direct the communication between a product user and an agent, the more expensive for the manufacturer to convey the product information.

Another type of contact medium is product user self-support obtained through network 14 and product self-help center 18. One example of a product user self-help center 18 is an interactive web site that accepts user inquiries and associates the inquires with a script 20 to attempt to provide the product user with desired product information. Another example of a product user self-help center 18 is a self-help module 26 loaded on an information handling system product that updates script content from a remote product self-help center 18. Product user self-help navigation through a script is logged by labeled references, a time stamp and product identification in log 22. For instance, a product user 12 navigates through a web-based script with a browser to isolate and correct a problem, such as slow operation of an information handling system. Each script page viewed by the product user is logged with a labeled reference associated with the page. Ideally the script narrows the product users inquiry from a general to a more specific nature until a page is displayed that resolves the product user's inquiry. The product manufacturer attempts to design and update page content to provide a product user with desired product information in an efficient and quick manner.

Event tracking system 10 obtains logs 22 from plural contact mediums and presents product user 12 interactions with product information through an intuitive event tracking graphical user interface display 28. Event log module 30 interfaces with the various contact mediums, such as product call center 16 and product self-help center 18, to receive logs 22 for analysis by event modeling engine 32. Event modeling engine 32 identifies contact sessions of a product user by associating contacts from the logs of the plural contact mediums that have the same product or product user identification code and that occur within a predetermined time period based on the time stamps. Thus, event modeling engine 32 identifies contact sessions that transition from a first contact medium to a second contact medium by ordering related contacts in a temporal relationship. For instance, a product user who makes a failed attempt to troubleshoot an information handling system difficulty through a self-help reference and then calls telephone support will have the self-help and telephone support contacts related in a contact session. Analysis of contact sessions that transition from less expensive to more expensive product support scripts allows alterations to the less expensive scripts to address deficiencies that lead product users to turn to more expensive scripts, and thus reduce costs while also providing an improved user experience.

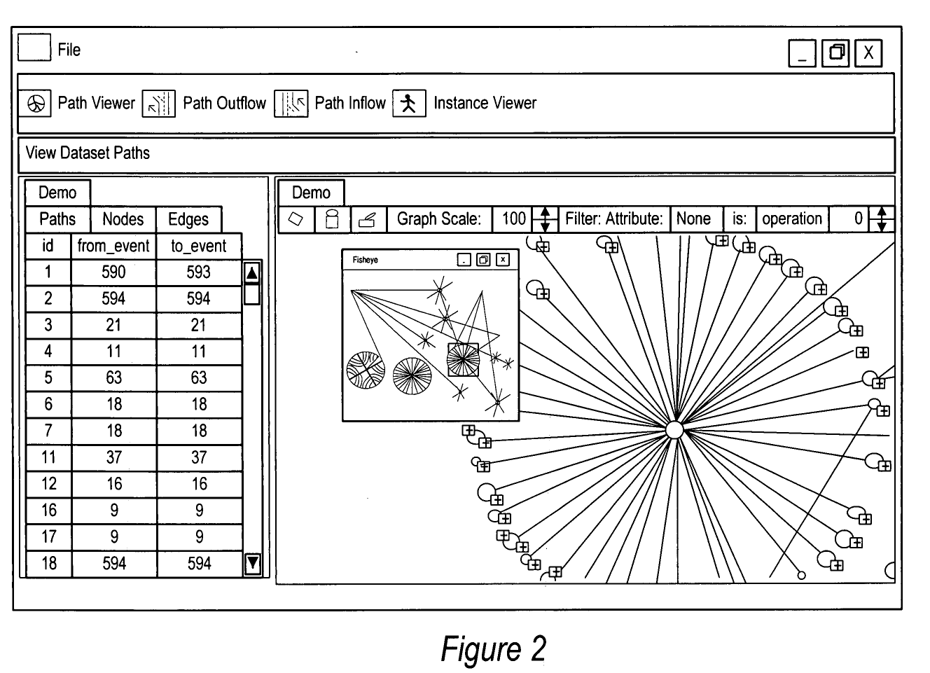

In order to effectively display contact sessions determined by event modeling engine 32, event tracking graphical user interface module 34 applies the contact session information to generate a directed graph such as is depicted by FIG. 2. Root nodes 42 of the directed graph has an in degree of zero, meaning that no other nodes send traffic to the root node. Children nodes 44 extend from root node 42 with edges 46 so that transitions between a first labeled reference to a second labeled reference in a contact session are intuitively displayed. Edges 46 indicate that the source and target nodes connected by an edge occurred in succession during a product user support session. For instance, a first node associated with a self-help URL identifier connected by an edge to a second node associated with a telephone agent script location represents a user interaction to obtain information that transitioned between contact mediums. The relationship between nodes to determine a contact session path is generated from a common product user identifier interacting with product information within a predetermined time period.

Event tracking GUI module 34 adapts the presentation of the directed graph to highlight desired relationships between nodes, such as by displaying nodes and edges with various colors or dimensions to reflect node or edge characteristics, such as quality and volume characteristics. One example of a characteristic that is highlighted is the transition of a user inquiry from one contact medium to another. For instance, highlighting transitions from a relatively low expense contact medium, such as web-based self-help, to a relatively high expense contact medium, such as communication with an agent, helps to identify self-help scripts in need of improvement relating to the subject matter of subsequent telephone script subject matters. As a specific example, a self-help article that provides incorrect instructions for loading a printer driver will result in an edge that transitions to a telephone contact node with a relatively high volume as system users attempt to obtain correct instructions. Other manipulations of the directed graph display aid in identification of desired interaction flow patterns. A path out flow engine 36 prepares display of unidirectional outward flowing paths that illustrate each root node and the children nodes that extend from each root node to show the paths of users from beginning to end of contact sessions. A path inflow engine 38 prepares an opposite display to illustrate all of paths followed by a user to get to a selected destination node. An instance engine 40 prepares the display having the finest granularity to explore the actual instance data that generated a displayed node or edge.

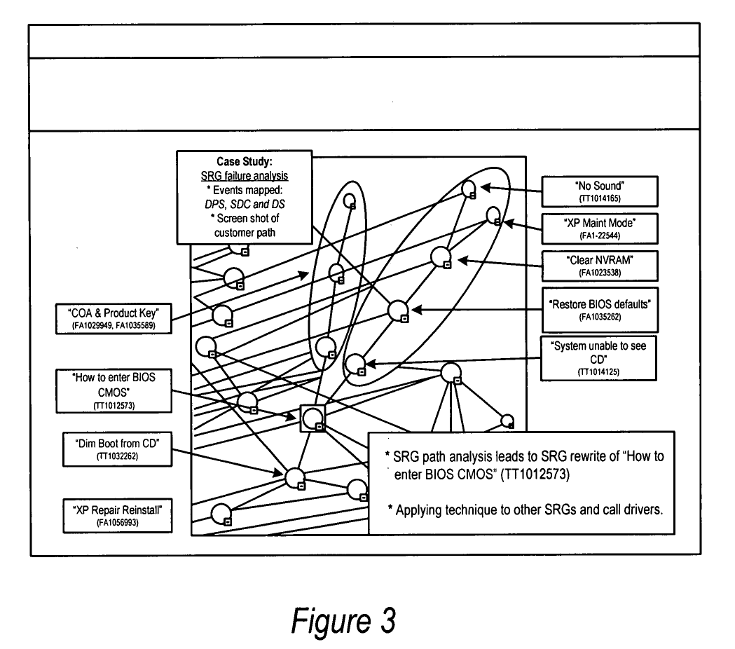

Referring now to FIG. 2, one example of a directed node graph for plural contact mediums is depicted. A fisheye view 48 displays all contact nodes with edges that interconnect nodes related by a customer transition from one node to another. An expansion box 50 in fisheye view 48 shows the portion of the directed graph that is blown-up in the main display space. Data used to build the directed graph is displayed in a data area 52 so that selection of a displayed node 44 or a line in data area 52 will allow detailed information about the node. As depicted by FIG. 3, once a characteristic of interest is identified in the directed graph, such as an edge having a predetermined relative volume of transitions from self-help to agent-based support, detailed views of the directed graph allow analysis to alter the content associated with nodes that has negatively impacted product user interactions. For instance, an operating system repair failure that fails due to inability of an information handling system to read from a CD leads to a node associated with presentation of information for entering BIOS CMOS. After reading this information, a number of product users successfully input needed information, such as the product key, to correct the boot issue while others follow a path that corrects for a loss of sound operation because a node on that path discusses CD failure with the operating system running. By correcting the display of information relating to entry of BIOS CMOS, an information handling system manufacturer is better able to direct product users to desired information and away from rabbit trails.

Although the present invention has been described in detail, it should be understood that various changes, substitutions and alterations can be made hereto without departing from the spirit and scope of the invention as defined by the appended claims.

1. A system for event tracking across plural contact mediums, the events associated with the providing of product information to product users, the system comprising:
an event log module operable to accept one or more event logs from each of the plural contact mediums, each event log having plural contact sessions, each contact session having one or more time-stamped user interactions, each interaction with a labeled reference, each labeled reference providing information about the product;
an event modeling engine interfaced with the event log module and operable to compile the event logs as a directed graph having a node for each labeled reference, the nodes interconnected by edges derived from the time stamps to order nodes according to a temporal relationship of customer interactions in a contact session through one or more of the contact mediums; and
an event tracking graphical user interface interfaced with the event modeling engine and operable to display the directed graph.

2. The system of claim 1 wherein one or more contact sessions comprise contacts through both a self-support module associated with the product and a telephone conversation.

3. The system of claim 1 wherein one or more contact sessions comprise contacts through both a web-based support module associated with the product and a telephone conversation.

4. The system of claim 1 wherein the product comprises an information handling system.

5. The system of claim 1 wherein the event tracking graphical user interface is further operable to highlight predetermined paths from a first contact medium to a second contact medium.

6. The system of claim 5 wherein the second contact medium comprises a telephone conversation.

7. The system of claim 6 wherein the predetermined edges are highlighted according to the relative volume of contacts associated with the edges.

8. The system of claim 1 wherein the contacts comprise user inquires for troubleshooting support associated with an information handling system product.

9. The system of claim 1 further comprising a path inflow engine interfaced with the event tracking graphical user interface and operable to display edges associated with contact sessions that have a user interaction from nodes of the directed graph into a selected node.

10. The system of claim 1 further comprising a path outflow engine interfaced with the event tracking graphical user interface and operable to display edges associated with contact sessions that have a user interaction from a selected node out to nodes of the directed graph.

11. A method for event tracking across plural contact mediums, the events associated with the providing of product information to product users, the method comprising:
logging product user interactions through the contact mediums by product user identifications, product information labeled references and time stamps;
identifying contact sessions of product users, each contact session having one or more product information labeled references associated with a product user identification within a predetermined time;
compiling the contact sessions as a directed graph having a node associated with each product information labeled reference, the nodes interconnected by edges, each edge associated with a user interaction at two nodes within the predetermined time, the edges defining a path between nodes for each contact session; and
presenting a visualization of the contact sessions that highlights edges having a predetermined characteristic.

12. The method of claim 11 wherein logging product user interactions further comprises:
logging product user interactions through a telephone conversation with an agent, the product information labeled references comprising agent script references; and
logging product user interactions through a self-help module, the product information labeled references comprising self-help navigation references.

13. The method of claim 12 wherein the self-help navigation references comprise web page references of a web-based self-help module.

14. The method of claim 12 wherein the self-help navigation references comprise display page references of a self-help module loaded on the product.

15. The method of claim 12 wherein the product comprises an information handling system.

16. The method of claim 12 wherein the predetermined characteristic comprises a contact session having a path from a node associated with a self-help navigation reference to a node associated with an agent script reference.

17. The method of claim 12 wherein the predetermined characteristic comprises a predetermined number of outflow paths from one or more nodes.

18. The method of claim 12 wherein the predetermined characteristics comprise a predetermined volume of user interactions associated with a contact session path.

19. The method of claim 11 further comprising:
identifying one or more nodes associated with an edge having the predetermined characteristic; and
altering the information associated with a product information labeled reference of the identified node to impact user interactions associated with generation of the predetermined characteristic.

20. The method of claim 19 wherein the predetermined characteristic comprises a transition by a product user from interaction through a first contact medium to interaction through a second contact medium.
